(19) United States
(12) Patent Application Publication
(10) Pub. No.: US 2017/0120794 A1
(43) Pub. Date: May 4, 2017

(54) Dual Axis Tow Lift

(71) Applicant: Gerard Muegerl, Churubusco, IN (US)

(72) Inventor: Gerard Muegerl, Churubusco, IN (US)

(21) Appl. No.: 14/931,940

(22) Filed: Nov. 4, 2015

(51) Int. Cl. B60P 1/44; B66F 9/22

(52) U.S. Cl. CPC B60P 1/4414; B66F 9/22

(57) ABSTRACT

A tow trailer for use with a motor vehicle, the tow trailer having: a frame, the frame having a hitch; a fork assembly, the fork assembly rotatably attached to the frame; a pair of forks, the forks slidingly attached to the fork assembly; a hydraulic actuator, the hydraulic actuator, the actuator having a first hydraulic cylinder attached to the fork assembly at a point suitable to cause rotation of the fork assembly relative to the frame, the actuator further having a second hydraulic cylinder, the second hydraulic cylinder attached to the forks to selectively move the forks along a vertical axis independently of the fork assembly rotation.

### BACKGROUND

1. Field of the Invention

The present invention relates to a tow trailer for transporting cargo.

2. Description of the Related Art

Cargo is often transported and stored on pallets or in large cargo or shipping containers. Pallets are typically of a standard construction having two flat wooden platforms with wooden spacers therebetween creating a gap of several inches. The forks of a forklift may be inserted into this gap to lift the pallet and any materials thereon. Material on pallets or in shipping containers is typically transported by loading a number of pallets onto a large flatbed truck using a forklift, driving the loaded truck to the point of destination, and unloading the pallet by forklift at the destination. This method of transport is efficient for large numbers of pallets, but requires forklifts at both the point of origin and the delivery point, and a flatbed truck for transporting the pallet.

A variety of applications exist for the economical transport of a single pallet of material. In the landscaping business, for example, sod is generally purchased by the pallet. Standard truck-and-forklift delivery methods are acceptable when the particular landscaping project requires a number of pallets of sod; however, many landscaping projects arise requiting only a single pallet of sod, or less. Because of the considerable expense involved, the transport of a single pallet of material is generally cost-prohibitive using existing transport methods. Other prior art devices include:

U.S. Pat. No. 3,701,445 discloses a tiltable trailer having a goose neck that is attached to the front end of the bed of a trailer at a point located forwardly and downwardly from the leading edge of the trailer bed. The goose neck abuts the flat bed adjacent its front leading edge, and actuating hydraulic cylinders are housed within the goose neck at generally right angles to the line connecting the hinge and the top portion of the abutment means that is adjacent the leading edge of the bed. Threadways may be provided on opposite sides of the goose neck for supporting the wheels of vehicles on the goose neck portion. The trailer is preferably towed by a flat plate hinged to the front end of the goose neck on a horizontal axis, and the leading edge of which is notched to receive a post projecting vertically from the bed of a flat bed truck. Since only a post projects out of the bed of the truck, the truck can be used for other purposes when the trailer is removed. Landing legs are preferably provided on the goose neck between its hinge, and its abutment with the trailer bed. A winch may also be mounted in the goose neck forwardly of the actuating hydraulic cylinders.

U.S. Pat. No. 3,701,445 discloses a tilting bed trailer having a bed frame connectable at one end to a towing vehicle, and having supporting arms, ground wheels mounted on the supporting arms, the arms being connected for swinging movement at after ends to the frame so that when the arms are swung between horizontal and upwardly sloped positions the frame is moved between elevated and lowered positions.

U.S. Pat. No. 3,805,981 discloses a system for towing and operating a fork-lift trailer including an electrically motor-driven tractor towing a trailer having a fork-lift system thereon. The trailer includes means thereon independent of the operation of the tractor for selectively and cumulatively starting and activating the motor of the tractor to drive the tractor forwardly, thereby towing the trailer.

U.S. Pat. No. 3,966,064 discloses a multi-purpose vehicle which may be used for a variety of purposes, such for example, as a fork lift truck, a tow truck with a hoist, a tractor or truck for towing a four wheel vehicle, any of the foregoing in combination with each other or in combination with a load carrying bed or container, or a tractor for supporting and towing a semi-trailer, in combination with some of the foregoing. The vehicle comprises a sub-frame including a pair of beams which have a horizontal component adapted to rest on top of the usual longitudinally extending beams of the main frame of the tractor in a normal horizontal position, and a vertical component adapted to be pivotally connected to a support some distance above the main frame. When the sub-frame is swung upwardly about the pivot, its rear end moves in a direction away from the rear of the tractor frame, whereby lifting and hoisting mechanism carried at the rear of the sub-frame clears the rear of the tractor frame. The sub-frame, at its rear end, carries lift forks which are adjustable in a direction transversely of the sub-frame to accommodate loads of various sizes and widths. The sub-frame has side plates which cooperate with surfaces of the beams of the tractor frame to insure alignment of the sub-frame with the tractor frame. The side plates and the beams of the tractor frame have locking means to hold the sub-frame in its normal horizontal position and to relieve the sub-frame pivot of stresses applied through the fifth wheel. Additional locking means are carried by cross-members of the sub-frame and tractor beams for relief of transverse and longitudinal stresses.

U.S. Pat. No. 5,584,639 discloses a tow trailer assembly for towing a single pallet of material behind an automobile or truck and having a substantially rigid fork frame with apparatus for connecting the trailer to the towing vehicle at one end and forks for engaging and lifting the pallet at the other end. A wheel support frame is pivotally connected to the fork frame and a hydraulic lifting cylinder is provided for moving the wheels downward relative to the fork frame to raise the fork frame into a towing position with the load substantially centered over the trailer's wheels.

U.S. Pat. No. 5,967,733 discloses a hydraulic tilt frame trailer is shown having a main support frame which is tiltable between a generally horizontal position and a rearwardly inclined position for loading and unloading a freight container. The tilt frame is connected to the main support frame by a first pivot point and has an opposite extent which is connectable to a hauling vehicle at a ball connection which forms a second pivot point. The main frame and tilt frame are hydraulically actuated for tilting the main support frame at an upwardly inclined angle and for simultaneously tilting the tilt frame at an opposite, upwardly inclined angle, whereby the main support frame is tilted to the rearwardly inclined position for loading an unloading a container.

U.S. Pat. Nos. 7,326,022 and 7,534,084 discloses a modular tow trailer assembly tows cargo behind a motor vehicle. A base assembly pivotally connects to a fork assembly. A hydraulic lifting cylinder moves the wheels downward relative to the fork assembly to raise the fork assembly into a towing position with the load substantially centered over the trailer's wheels. The tow trailer is readily partially disassembled for fitting within a cargo container and transporting within a cargo carrier in field conditions.

However, for a variety of reasons, existing prior art devices for transporting a single pallet of material are less than entirely satisfactory. What is needed in the art is a dual axis device that can conveniently and simultaneously lift and tilt in order to transport materials.

### SUMMARY

In one exemplary embodiment, the present invention comprises a tow trailer for use with a motor vehicle, said tow trailer comprising: a frame, said frame comprising a hitch; a fork assembly, said fork assembly rotatably attached to said frame; a pair of forks, said forks slidingly attached to said fork assembly; a hydraulic actuator, said hydraulic actuator, said actuator comprising a first hydraulic cylinder attached to said fork assembly at a point suitable to cause rotation of said fork assembly relative to said frame, said actuator further comprising a second hydraulic cylinder, said second hydraulic cylinder attached to said forks to selectively move said forks along a vertical axis independently of said fork assembly rotation.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 is a side view of an exemplary fork assembly and hitch according to the present invention;

FIG. 2 is a perspective view of an exemplary fork assembly and hitch according to the present invention;

FIG. 3 is a side view of an exemplary fork assembly and hitch according to the present invention;

FIG. 4 is a rear view of an exemplary fork assembly and hitch according to the present invention;

FIG. 5 is a side view of an exemplary fork assembly and hitch according to the present invention in a raised position assembly or fork;

FIG. 6 is a side view of an exemplary fork assembly and hitch according to the present invention in a lowered position;

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

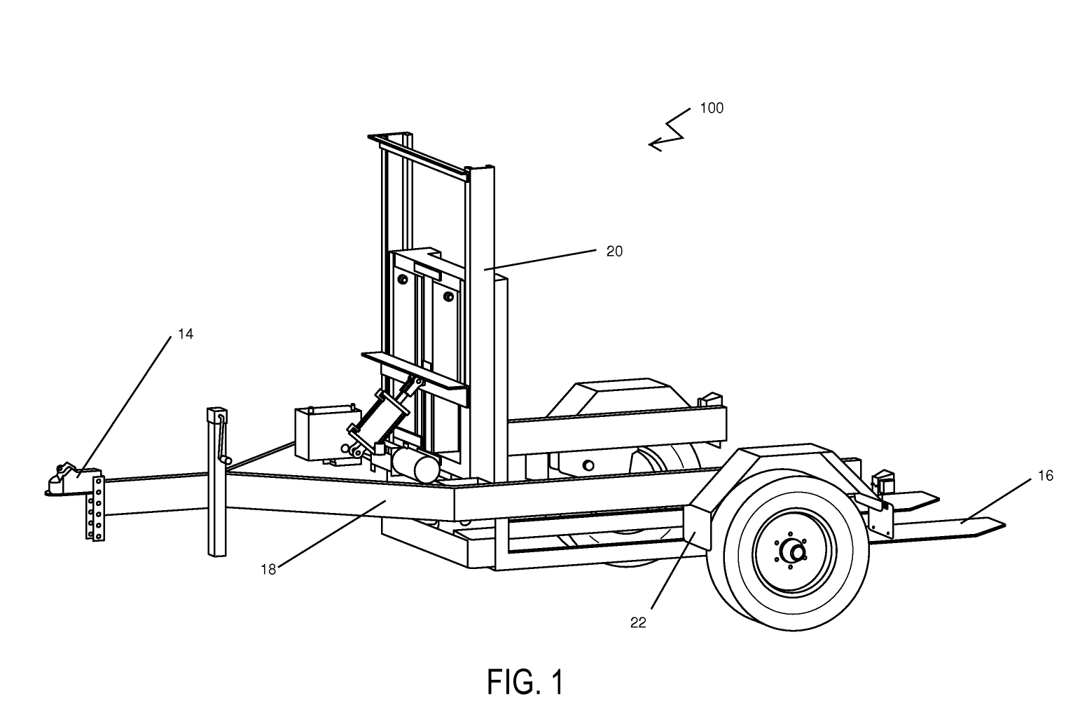

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown a side perspective view of an exemplary tow trailer 100 comprising a fork assembly 16 and hitch 14 according to the present invention. As illustrated in FIG. 1, tow trailer 100 generally comprises adjustable hitch 14, base assembly 18, a fork assembly 16, and backstop 20. Fork assembly 16 further comprises parallel horizontal forks 32. Fork assembly 16 may further comprise a lower bracket support connecting to the center of hitch 14.

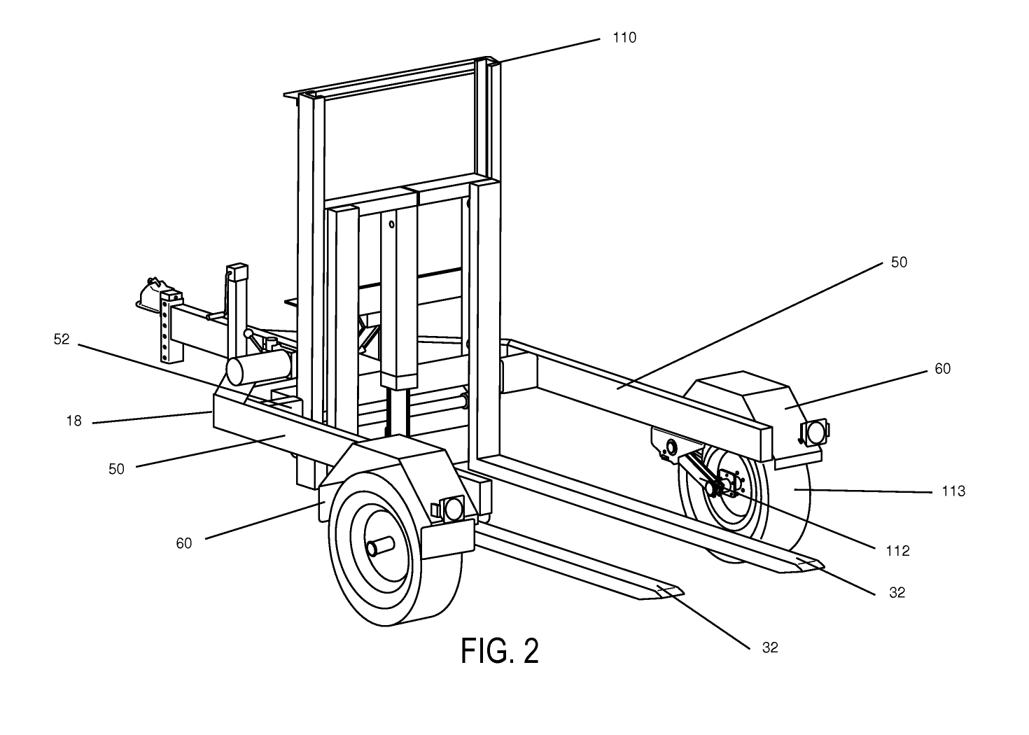

Referring now to FIG. 2, there is shown a rear perspective view of exemplary tow apparatus 100 according to the present invention including fork assembly 16 and hitch 14. Tow assembly 100 further comprises base frame 18 having with parallel base arms 50. The base arms 50 are arranged outside of forks 32 at a distance sufficient to allow clearance for a cargo loaded on forks 32. The cross base 52 is disposed between base arms 50. Upper bracket 170 attaches to the center of the cross base 52. Each base arm 50 has an open base end and wheel chamber 60 for releasably engaging a wheel connecting assembly 112 and wheel 113.

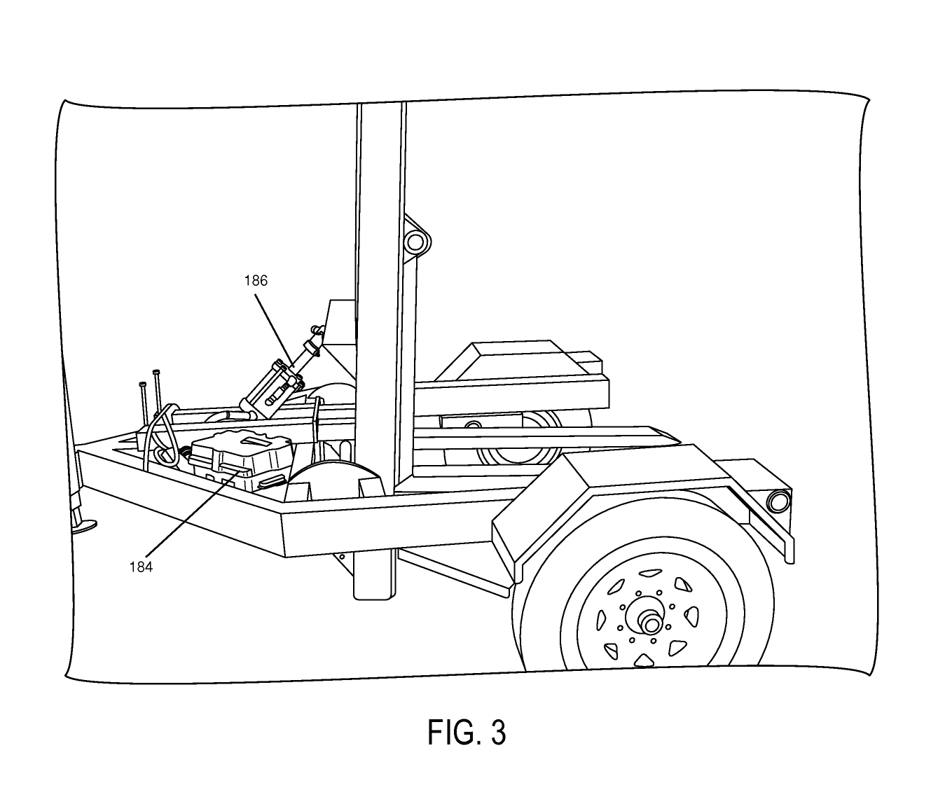

Referring now to FIG. 3, there is shown a side close up view of exemplary tow apparatus 100 according to the present invention including fork assembly 16 and hitch 14. A battery receiver, such as a shelf or a box, is disposed behind bracket 170. A battery 184 is prevented from shifting by a battery locking device, such as a tie, chain, cord, bracket, brace, and the like. Wiring connects the battery 184 to a hydraulic pump for inducing movement in fork assembly 16.

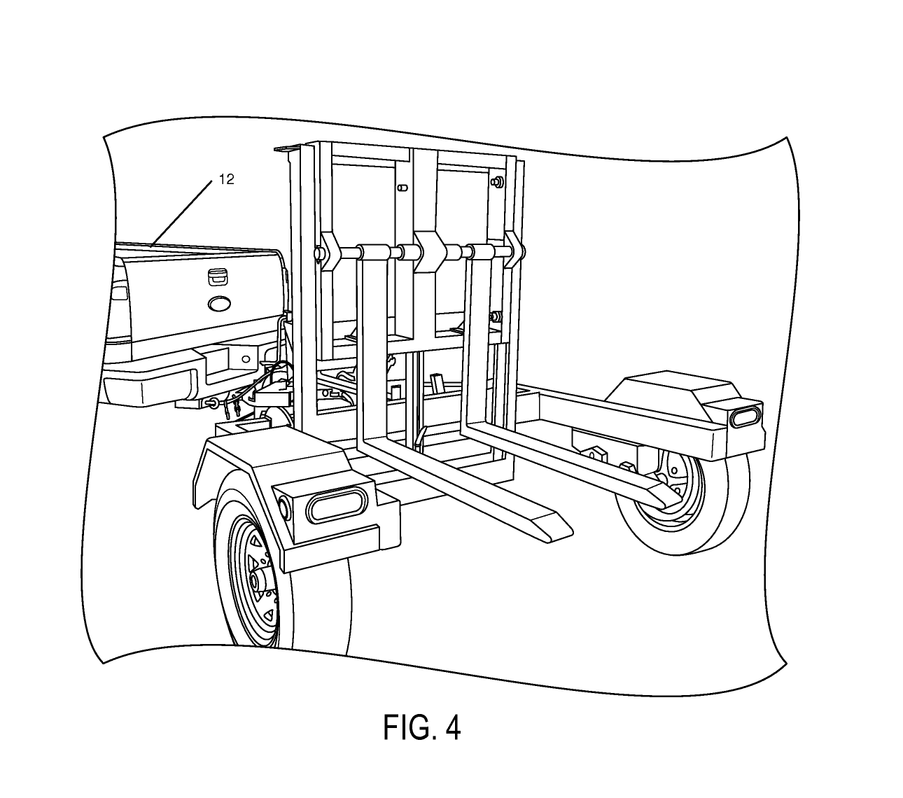

Referring now generally to FIG. 3 and to FIG. 4, lifting device, such as a hydraulic cylinder 168, pivotally mounts to an upper hydraulic bracket 170 attached to the base assembly 18 at the center of the cross base 52 to allow the hydraulic cylinder 168 to pivot about the upper bracket 170. The hydraulic cylinder 168 has no bending moment as the hydraulic cylinder 168 raises the forward end of the base assembly 18. The hydraulic cylinder 168 mounts to a lower hydraulic bracket 171 attached to the lower bracket support 30 of the fork assembly 16. Although a hydraulic cylinder is preferred, it will be clear to those skilled in the art that a winch or other lifting devices could be used.

A second lifting device, such as a hydraulic cylinder may mount to fork assembly 16 to linearly move fork assembly 16 along a vertical path. Although a hydraulic cylinder is preferred, it will be clear to those skilled in the art that a winch or other lifting devices could be used.

Each hydraulic cylinder is of a standard commercially available design, selected to have a lifting capacity sufficient to raise the forks of the loaded tow trailer, and a stroke of sufficient length to provide adequate ground clearance for the tow trailer. Each hydraulic cylinder is in fluid communication with at least one hydraulic pump in a conveniently accessible location. The hydraulic pump receives power from the battery 184, or alternatively, may be connected to a power outlet supplied on the tow vehicle.

Referring now to FIG. 4, there is shown a rear perspective of exemplary tow apparatus 100 according to the present invention including fork assembly 16 and hitch 14 attached to a vehicle 12. The tow trailer assemblies and braces are preferably rectangular or square steel tubing of sufficient structural strength to support the loaded tow trailer assembly during transit. Leaf springs may fasten to the bottom of the each base arm 50 of the base assembly 18.

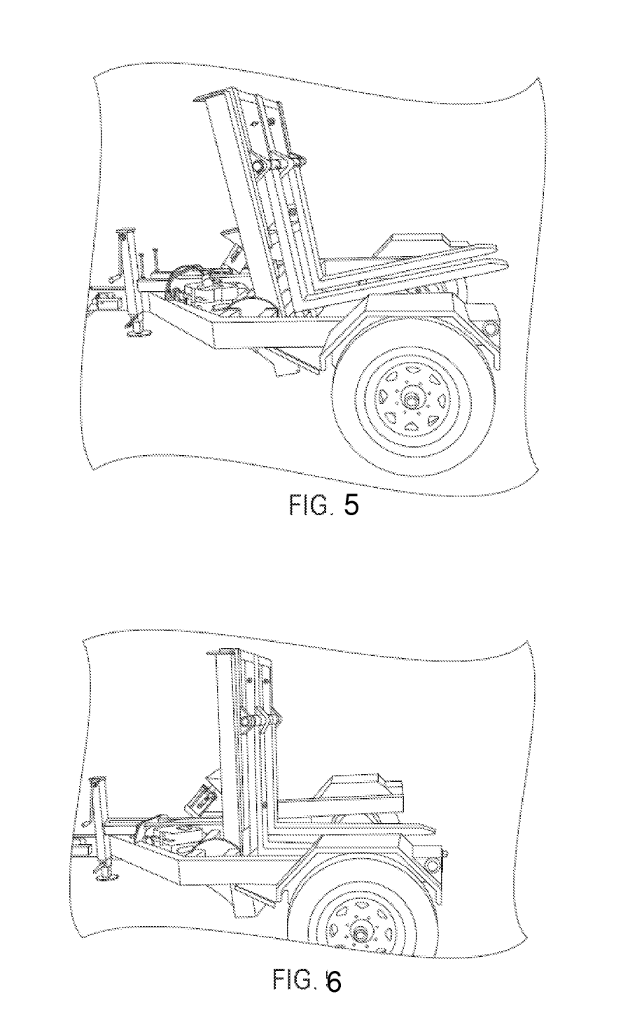

Referring now generally to FIG. 5, a side view of an exemplary fork assembly and hitch according to the present invention in a tilted position, and FIG. 6, a side view of an exemplary fork assembly and hitch according to the present invention in a lowered position, the operation of tow trailer assembly 100 is described as follows.

Tow trailer 100 couples with a towing vehicle using the hitch with or without the hitch extension. The hydraulic cylinder is lowered to a fully retracted position. The forks and fork receivers are positioned essentially horizontally and raised slightly above the ground. The tow trailer is towed to a position immediately in front of the cargo to be transported, and then moved backward such that the forks penetrate the pallet or slide under the cargo load. The tow trailer is moved backward until the forward end of the pallet or cargo load contacts the backstop indicating that the cargo is properly positioned over or slightly in front of the pivot axis. In order to provide a stable towing configuration, the load should be positioned on the forks such that its center of gravity is not behind the pivot axis. Such a loading configuration could cause the rear of the fork assembly to pivot downwardly about the pivot axis, resulting in an upward force on the hitch, and potentially uncoupling the tow trailer from the tow vehicle. By configuring the backstop, the forks and the base assembly as described above, the present invention properly positions the load's center of gravity in a stable towing configuration between the pivot axis and the hitch.

Once the cargo has been properly engaged, the tow trailer is moved to its raised or transport position. The operator activates the pump using the hydraulic actuator, thus causing the hydraulic cylinder to extend and move the base assembly's cross base upward relative to the lower bracket support of the fork assembly. As the cross base is raised, the base assembly pivots to move the forks upwardly relative to the wheels. Because the downward motion of the wheels is constrained by the ground, this motion causes the fork assembly to pivot upward about the hitch axis, thus raising the forks above the ground.

Because the entire length of the fork assembly pivots, a small angle of inclination of the fork assembly raises the forks to meet the ground clearance requirements without inclining the cargo so steeply as to cause the load to-shift or fall from the tow trailer. Once the tow trailer is fully raised, locking straps can be installed on lugs located on the base assembly's cross base and the lower bracket support. The hydraulic pump and the hydraulic cylinder are deactivated. The motor vehicle tows the tow trailer to the destination where the above sequence of operations is reversed to unload the cargo.

The tow trailer can transport larger cargo loads without the need for forklifts or a large flatbed truck and can carry these larger loads a distance above the ground sufficient to comply with Department of Transportation ground clearance regulations without tilting the load so far beyond the horizontal position that the cargo falls off of the pallet.

The backstop limits the insertion of the forks into the pallet or under the shipping container to ensure proper positioning of the load. In this manner, the weight of the load is centered over the forks, or slightly forward of the wheels of tow trailer and the loaded tow trailer is stable.

Once the pallet and cargo are in position, the tow trailer can safely travel at highway speeds. The tow trailer has the ability to load and unload the standard pallet under its own power, with the ability to transport on rough terrain or on the highway. The tow trailer can haul large and oversized cargo when attached to a car, pickup, Humvee or other truck using a standard ball or pintle hitch. If a pintle hitch is used, the ball adapted tongue can be stored in the supplemental vertical axle support. At the destination site, the forks can be raised up to ten feet for loading and/or unloaded cargo.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A tow trailer for use with a motor vehicle, said tow trailer comprising: a frame, said frame comprising a hitch; a fork assembly, said fork assembly rotatably attached to said frame; a pair of forks, said forks slidingly attached to said fork assembly; a hydraulic actuator, said hydraulic actuator, said actuator comprising a first hydraulic cylinder attached to said fork assembly at a point suitable to cause rotation of said fork assembly relative to said frame, said actuator further comprising a second hydraulic cylinder, said second hydraulic cylinder attached to said forks to selectively move said forks along a vertical axis independently of said fork assembly rotation.

2. The tow trailer assembly of claim 1, where the forks are removably attached to the fork assembly.

3. The tow trailer assembly of claim 1, wherein the frame further comprises: a vertical axle support mounting to an upright; a horizontal axle support attached to the vertical axle support and a pivot axle; and a diagonal axle support attached to the vertical axle support and a horizontal axle support.
